(19) United States
(12) Patent Application Publication
(10) Pub. No.: US 2012/0076474 A1
(43) Pub. Date: Mar. 29, 2012

(54) VIDEO PLAYING DEVICE AND METHOD

(75) Inventors: YU-KAI XIONG, Shenzhen City (CN); XIN LU, Shenzhen (CN); SHIH-FANG WONG, Tu-Cheng (TW); DONG-SHENG LV, Shenzhen City (CN); XIN-HUA LI, Shenzhen City (CN)

(73) Assignees: HON HAI PRECISION INDUSTRY CO., LTD., Tu-Cheng (TW); Fu Tai Hua Industry (ShenZhen) Co., Ltd., ShenZhen City (CN)

(21) Appl. No.: 13/045,197

(22) Filed: Mar. 10, 2011

(30) Foreign Application Priority Data
Sep. 27, 2010 (CN) 201010293423.9

(51) Int. Cl. H04N 5/783

(52) U.S. Cl. 386/343; 386/E05.052

(57) ABSTRACT

A video playing device includes a playing unit, a selection unit, a comparison unit, and an acquisition unit. The playing unit is adapted to play a video stored in a memory which is further used for storing a unique identifier of each frame of the video. The selection unit selects two sequential frames of the video from the memory. The comparison unit compares the two selected sequential frame to determine whether the two selected sequential frames are the same, and generates an acquisition signal when it is determined that the two selected sequential frames are not the same. The acquisition unit acquires the unique identifiers of the selected frames from the memory in response to the acquisition signal. The playing unit is further adapted to play the video stored in the memory according to the acquired unique identifiers.

### BACKGROUND

1. Technical Field

The present disclosure relates to video playing devices, and more particularly to a playing method used by the video playing devices.

2. Description of Related Art

For security, cameras are widely used for area monitoring. However, video captured by the cameras may be many hours or days long and very time consuming to review.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of a video playing device in accordance with an exemplary embodiment.

FIG. 2 is a flowchart of a video playing method in accordance with an exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

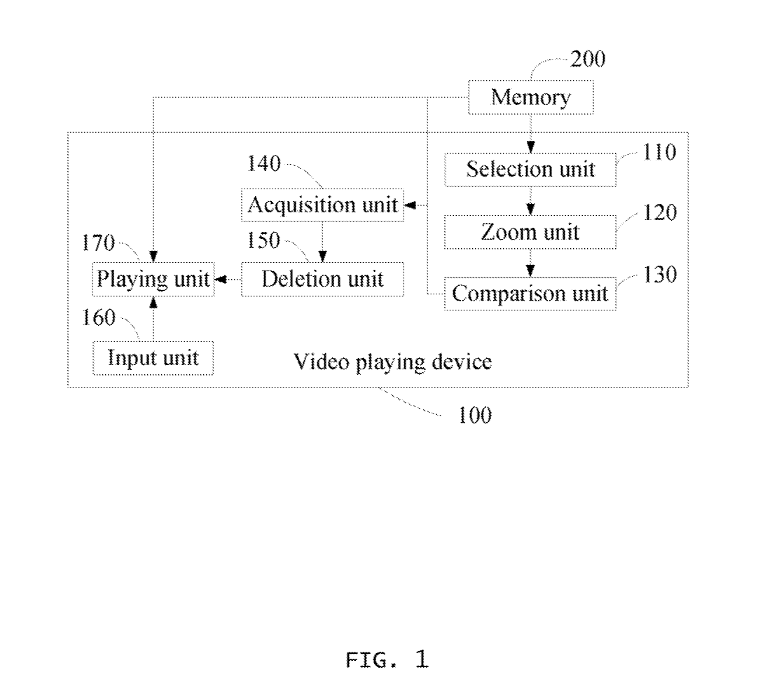

Referring to FIG. 1, a video playing device 100 is connected to a built-in or external memory 200. The memory 200 is used for storing video captured by a camera which may be built in the video playing device 100, and for storing a unique identifier for each frame of the video, such as a time stamp. The memory 200 may be a secure digital memory card, a mobile hard disc, and so on. The video playing device 100 is used for reproducing the video stored in the memory 200.

The video playing device 100 includes a selection unit 110, a zoom unit 120, a comparison unit 130, an acquisition unit 140, a deletion unit 150, an input unit 160, and a playing unit 170. The selection unit 110 is used for selecting two sequential frames of the video from the memory 200. The zooming unit 120 is used for zooming in or out the two selected frames according to user input.

The comparison unit 130 is used for comparing the two selected frames to determine whether they are the same, and generating an acquisition signal when it is determined the two selected frames are not the same.

The acquisition unit 140 is used for acquiring the unique identifiers of the selected frames from the memory 200 in response to the acquisition signal.

The deletion unit 150 is used for deleting redundancy of the acquired unique identifiers. Because each frame is used in two comparisons, once with a previous frame and once with a subsequent frame, it may be that changes are noted in both comparisons thereby, without the deletion unit 150, the unique identifier of the frame would be acquired twice.

The input unit 160 is used for generating an input signal in response to user input. The input unit 160 may be one or more keys arranged on the video playing device 100, or selectable menu items displayed by the video playing device 100.

The playing unit 170 is used for playing the video stored in the memory 200 according to the remaining acquired unique identifiers after deleting the redundancy in response to the input signal, so that only clips of the video in which changes in an area under surveillance occur are played for viewing, thus possibly saving a great deal of time.

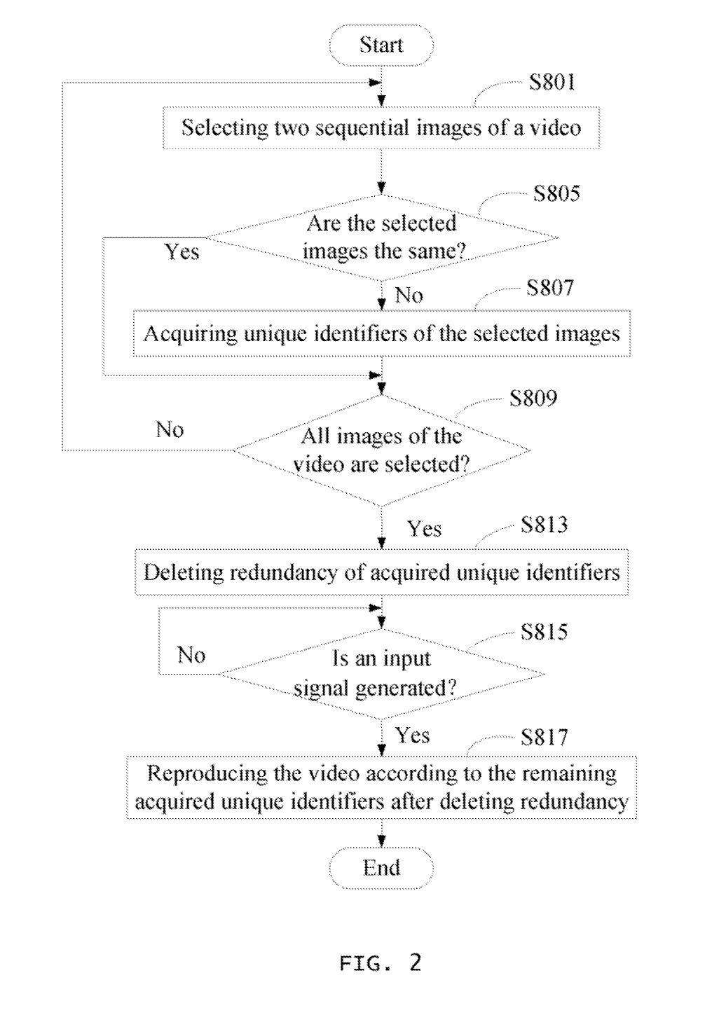

Referring to FIG. 2, a video playing method is used for controlling a video playing device to play a video. The video may be stored in a memory connected to the video playing device, or a memory built in the video playing device. The memory is also used for storing a unique identifier of each frame of the video, such as a time stamp. The method includes the following steps.

In step S801, two sequential frames of the video are selected from the memory according to the unique identifiers. That is, initially, the first two frames of the video are selected, then the second frame and third frame are selected, then third and fourth, and so on.

In step S805, it is determined whether the two selected sequential frames are the same. If it is determined the two selected sequential frames are not the same, step S807 is implemented and then step S809 is implemented. If it is determined that the two selected sequential frames are the same, step S809 is implemented.

In step S807, the unique identifiers of the selected sequential frames are acquired from the memory.

In step S809, it is determined whether all frames of the video are selected. If some frames of the video are not selected, return to step S801. If the all frames of the video are selected, step S813 is implemented.

In step S813, redundancy of the acquired unique identifiers is deleted. Because each frame is used in two comparisons, once with a previous frame and once with a subsequent frame, it may be that changes are noted in both comparisons thereby, without step S813, the unique identifier of the frame would be acquired twice.

In step S15, it is determined whether an input signal is generated. If the input signal is generated, step S817 is implemented. If the input signal is not generated, step S815 is repeated. In the embodiment, one key is arranged on the video playing device, and the input signal is generated when the key is pressed. In the other embodiments, one menu item is displayed by the video playing device, and the input signal is generated when the menu item is selected.

In step S817, the video stored in the memory is reproduced according to the remaining acquired unique identifiers after deleting the redundancy , so that only clips of the video in which changes in an area under surveillance occur are played for viewing, thus possibly saving a great deal of time.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A video playing device, comprising:
a playing unit adapted to play a video stored in a memory which is further used for storing a unique identifier of each frame of the video;
a selection unit adapted to select two sequential frames of the video from the memory;
a comparison unit adapted to compare the two selected sequential frame to determine whether the two selected sequential frames are the same, and generate an acquisition signal when it is determined that the two selected sequential frames are not the same; and
an acquisition unit adapted to acquire the unique identifiers of the selected frames from the memory in response to the acquisition signal;
wherein the playing unit is further adapted to play the video stored in the memory according to the acquired unique identifiers.

2. The video playing device according to claim 1, further comprising a deletion unit adapted to delete redundancy of the acquired unique identifiers, thus the playing unit playing the video stored in the memory according to the remaining acquired unique identifiers after deleting the redundancy.

3. The video playing device according to claim 1, further comprising a zoom unit for zoom in or out the selected frames.

4. The video playing device according to claim 1, further comprising an input unit for generating an input signal in response to user input, and the playing unit playing the video stored in the memory according to the acquired unique identifiers in response to the input signal.

5. The video playing device according to claim 1, wherein the unique identifier is a time stamp.

6. A video playing method adapted to control a video playing device to play a video stored in a memory, the memory also used for storing a unique identifier of each frame of the video, the video playing method comprising:
selecting two sequential frames of the video from the memory;
determining whether the two selected sequential frames are the same;
if the two selected sequential frames are not the same, acquiring the unique identifiers of the selected frames from the memory;
determining all frames of the video are selected;
if some frames of the video are not selected, selecting two sequential frames of the video from the memory is repeated; and
if the all frames of the video are selected, reproducing the video stored in the memory according to the acquired unique identifiers.

7. The method according to claim 6, further comprising:
if the two selected sequential frames are the same, the step of determining all frames of the video are selected is implemented.

8. The method according to claim 6, wherein the step that if all frames of the video are selected, reproducing the video stored in the memory according to the acquired unique identifiers further comprises:
if the all frames of the video are selected, deleting redundancy of the acquired unique identifiers; and
reproducing the video in the memory according to the remaining acquired unique identifiers after deleting the redundancy.

9. The method according to claim 6, wherein the step that if all frames of the video are selected, reproducing the video stored in the memory according to the acquired unique identifiers further comprises:
if the all frames of the video are selected, determining whether an input signal is generated; and
if the input signal is generated, reproducing the video stored in the memory according to the acquired unique identifiers.

10. The method according to claim 9, further comprising:
if the input signal is not generated, the step of determining whether the input signal is generated is repeated.

11. The method according to claim 6, wherein the unique identifier is a time stamp.
